(19) United States
(12) Patent Application Publication
(10) Pub. No.: US 2017/0045985 A1
(43) Pub. Date: Feb. 16, 2017

(54) DISPLAY PANEL AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Zhenhua LV, Beijing (CN); Lei WANG, Beijing (CN); Xiaochuan CHEN, Beijing (CN); Haisheng WANG, Beijing (CN); Yanchen LI, Beijing (CN); Zhiying BAO, Beijing (CN); Yong ZHANG, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/022,529

(22) PCT Filed: Sep. 16, 2015
(86) PCT No.: PCT/CN2015/089756

§ 371 Date: Mar. 16, 2016

(30) Foreign Application Priority Data
Mar. 6, 2015 (CN) 201510099192.0

(51) Int. Cl. G06F 3/041; G06F 3/044

(52) U.S. Cl. CPC G06F 3/0416; G06F 3/044; G06F 3/0412; G06F 2203/04111

(57) ABSTRACT

The present disclosure provides a display panel and a display device, and the display panel includes an array substrate, a color filter substrate and at least a spacer disposed between the array substrate and the color filter substrate, where the array substrate or the color filter substrate is provided with plural touch electrodes disposed in a same layer and separated from each other, plural lines arranged in different layers from the touch electrodes, and an insulation layer disposed between the touch electrodes and the lines. The insulation layer is provided with via holes, for the connection of the corresponding touch electrodes and the lines, and the via hole is located within a region of the insulation layer on which an orthographic projection of the spacer is projected.

### CROSS-REFERENCE TO RELATED APPLICATION

The present application claims a priority of the Chinese patent application No. 201510099192.0 filed on Mar. 6, 2015, where the entire contents by reference are incorporated herein.

### TECHNICAL FIELD

The present disclosure relates to touch screen technology, and more particularly, to a display panel and a display device that are able to boost the display performance.

### BACKGROUND

The touch portion of an in-cell touch screen comprises a touch electrode disposed in a display area, and the touch electrode is connected to a touch chip disposed at the periphery of the display area, to realize a touch function; therefore, wiring lines are also provided in the display area to connect the touch electrode and the peripheral touch chip.

In the prior art, the wiring lines and the touch electrodes can be arranged in a same layer. However, once the wiring lines and the touch electrodes are disposed in the same layer in which some space is required to accommodate lines; therefore, the remaining space that can be allocated to the touch electrode is substantially diminished, leading to reduced precision of touch, and even blind zones. Therefore, to boost the touch precision, more and more in-cell touch screens adopt the scheme of a different-layer setting for lines and touch electrodes.

When the lines and the touch electrodes are disposed in the different layers, via holes are required to connect the both. However, the setting of via holes in the display area will apparently bring about adverse effects to display; therefore, how to diminish the adverse effects on display caused by the via holes that connects the lines and the touch electrodes becomes the urgent problem of improving the performance of the in-cell touch screen to be settled.

### SUMMARY

The objective of disclosed embodiments is to provide a display panel and a display device, reducing adverse effects caused by via holes which connect the lines and the touch electrodes in an in-cell touch screen.

To realize the aforementioned objective, the disclosed embodiments provide a display panel, which comprises an array substrate, a color filter substrate and at least one spacer disposed between the array substrate and the color filter substrate, where the array substrate or the color filter substrate is provided with plural touch electrodes disposed in a same layer and separated from each other, a plurality of lines arranged in different layers from the touch electrodes, and an insulation layer disposed between the touch electrodes and the lines, wherein the insulation layer is provided with via holes for connecting the corresponding touch electrodes and the lines, and the via hole being located within a region of the insulation layer on which an orthographic projection of the spacer is projected.

The aforementioned display panel, wherein the touch electrode is a self-capacitance touch electrode or a mutual-capacitance touch electrode.

The aforementioned display panel, wherein the spacer comprises a main spacer and an auxiliary spacer, where the via holes are located within a region of the insulation layer on which an orthographic projection of the main spacer is projected.

The aforementioned display panel, wherein the number of the via holes is less than a first threshold, such that the number of the main spacers, where there is no via holes within the areas of the insulation layer on which the orthographic projection of the main spacers are projected, exceeds a second threshold.

The aforementioned display panel, wherein at least one main spacer, where there is no via holes within the area of the insulation layer on which the orthographic projection of the at least one main spacer is projected, is arranged between main spacers corresponding to adjacent via holes which correspond to a same line.

The aforementioned display panel, wherein the plurality of touch electrodes have the same size and shape and are arranged in a matrix manner, where portions of the plurality of lines located in the display area are disposed in parallel, and have the same length and width, and the number of the lines located in a region covered by each column of touch electrodes or each row of touch electrodes is identical.

The aforementioned display panel, wherein the lines are used for transmitting touch detection signals during a touch stage and for transmitting common electrode signals to the touch electrodes during a display stage.

The aforementioned display panel, wherein the plural touch electrodes have the same size and shape and are arranged in a matrix manner, within a column of touch electrodes or a row of touch electrodes, the number of the via holes corresponding to each touch electrode is identical and the positions corresponding to the touch electrodes are same.

To realize the aforementioned objective, the disclosed embodiments further provide a display device comprising the aforementioned display panel.

In an embodiment, the via hole connecting a touch electrode and a line disposed in different layers is located within a region of the insulating layer on which the orthographic projection of a spacer is projected, which can accordingly exploit an opaque spacer to block the via hole, thereby substantially diminishing the adverse effects on the display brought by the presence of the via hole.

### BRIEF DESCRIPTION OF THE DRAWINGS

FIG. 1 is a schematic view showing the relative relationship between a via hole and a spacer according to at least on embodiment of the present disclosure;

FIG. 2 is a schematic view to illustrate the scheme of an embodiment that can be used to reduce the adverse effects on the display caused by the presence of the via hole according to at least on embodiment of the present disclosure;

FIG. 3 is another schematic view to illustrate the scheme of an embodiment that can be used to reduce the adverse effects on the display brought by the presence of the via hole according to at least on embodiment of the present disclosure;

FIG. 4A is a schematic view showing a consecutive arrangement of the via holes with respect to the spacers;

FIG. 4B is a schematic view showing an inconsecutive arrangement of the via holes with respect to the spacers; and

FIG. 5 is a schematic view showing a relative position relationship among touch electrodes, lines and via holes according to at least on embodiment of the present disclosure.

### DETAILED DESCRIPTION

Unless otherwise defined, any technical or scientific term used herein shall have the common meaning understood by a person of ordinary skills. Such words as “first”, “second” and the like used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

In an embodiment, the via hole used to connect a touch electrode and a line which are arranged at different layers is located within an area of the insulation layer on which the orthographic projection of a spacer is projected. Therefore, an opaque spacer is used to block the via hole, thereby reducing the adverse effect caused by the presence of the via hole on the display.

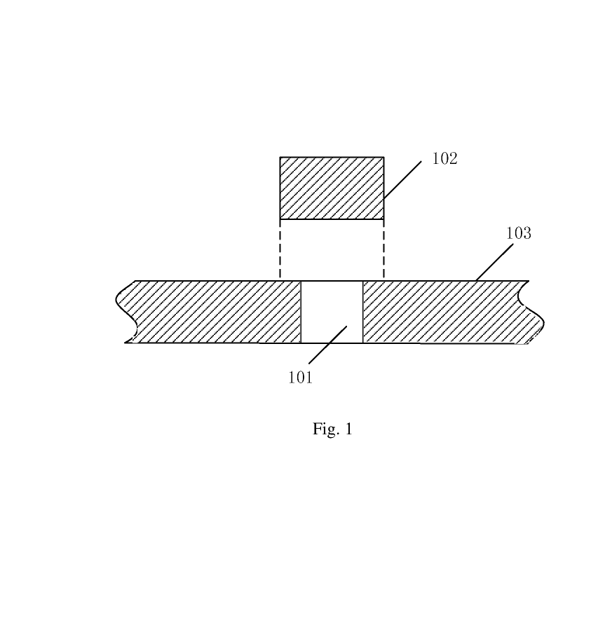

A display panel of an embodiment of the present disclosure includes an array substrate, a color filter substrate and at least one spacer disposed between the array substrate and the color filter substrate, where the array substrate or the color filter substrate is provided with plural touch electrodes disposed in a same layer and separated from each other, plural lines arranged in a layer different from the touch electrodes, and an insulation layer disposed between the touch electrodes and the lines, where the insulation layer is provided with via holes, for the connection of the corresponding touch electrodes and the lines, with reference to FIG. 1, the via hole 101 is located within an area of the insulation layer 103 on which the orthographic projection of a spacer 102 is projected.

In an embodiment, a via hole, connecting the touch electrodes and the lines which are arranged in different layers, is located within an area of the insulation layer on which the orthographic projection of a spacer is projected. An opaque spacer is used to block the via hole, thereby reducing the adverse effect brought by the presence of the via hole on the display. Explanation is as follows.

The reason why the via hole will affect the display is that the via hole will produce a variety of effects on light. Therefore, these effects can be considered from two aspects, which are described below.

As mentioned above, the reason why the via hole will affect the display, viewing from one aspect, is that it will produce a variety of effects to the light. Therefore, reducing the amount of the light that the via hole can affect, will for sure reduce its impact on the display. In other words, if the amount of the light irradiated on the region that the via hole is located can be diminished, the impact brought by the via holes on the display can then be declined.

Viewing from the other aspect, the impact to the display by the via hole is because the light changed by the via hole can be seen by the user; therefore, if the amount of light affected by the via hole and seen by the user can be diminished, the impact on the display by the via hole can also be declined.

It could be found through integration of the aforementioned two aspects that when the via hole 101 is located within an area of the insulation layer 103 on which an orthographic projection of the spacer 102 is projected, a first direction pointed from the spacer to the via hole is either identical to the direction of light transmission, or opposite to the direction of light transmission. When the first direction is identical to the direction of the light transmission, the light will be blocked by the spacer, reducing the amount of light irradiated on the area that the via hole is located. On the other hand, when the first direction is opposite to the direction of the light transmission, the light changed by the via hole will be blocked by the spacer, reducing the amount of light changed by the via hole and seen by the user, and the impact on the display by the via hole can be declined.

Explanation is as follows with reference to the figures.

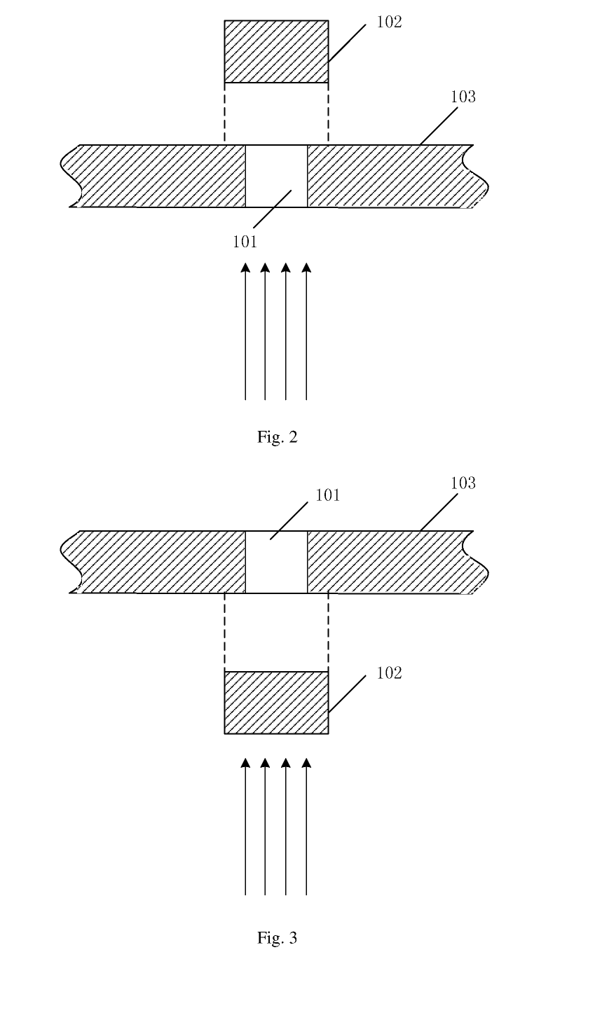

Under ordinary circumstances, a touch electrode can be arranged in the array substrate, or arranged in the color filter substrate. When the touch electrode is arranged in the array substrate, the relationship among the spacer 102, the via hole 101 and the light is illustrated in FIG. 2, where the first direction pointed from the spacer to the via hole is opposite to the direction of the light transmission, and at least part of the light changed by the via hole will be blocked by the spacer. In the prior art, the light changed by the via hole will directly go through the display and seen by the user; therefore, the display panel according to the disclosure can reduce the adverse effects on the display brought by the presence of the via hole.

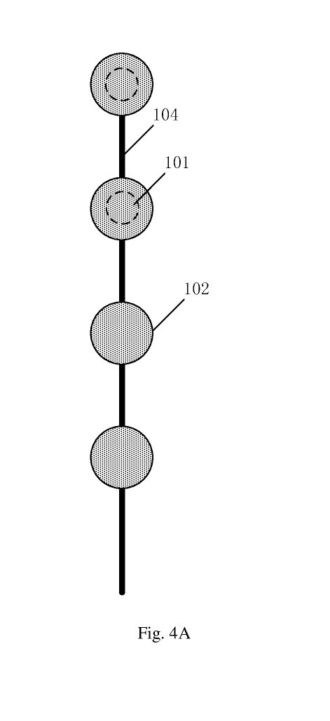

When the touch electrode is arranged in the color filter substrate, the relationship among the spacer 102, the via hole 101 and the light is illustrated in FIG. 3, where the first direction pointed from the spacer to the via hole is identical to the direction of light transmission, and at least a part of the light originally irradiated to the via hole will be blocked by the spacer 102 and eventually fails to irradiate the via hole; that is, the scheme of the embodiment reduces the amount of light affected by the via hole, therefore, the display panel of the embodiment reduce the adverse effects on the display brought by the presence of the via hole.

It should be understood that the aforementioned FIGS. 2 and 3 are the illustrations for an example of a transmissive type display panel with a self-equipped backlight, where the display panel of the embodiment may also be a reflective display panel or a transflective display panel, with the fact that all have the same principle, which is to reduce the amount of light irritated on the area where the via hole is located or to reduce the portion of light affected by the via hole and seen by the user, and it is not intended to repeat it in detail herein.

It means that in other embodiments, the aforementioned touch electrode could be disposed in an array substrate of the transmissive display panel, in a color filter substrate of the transmissive display panel, in an array substrate of the reflective display panel, in a color filter substrate of the reflective display panel, in an array substrate of the transflective display panel, or in a color filter substrate of the transflective the display panel.

The display panel is an important component of a display device. In general, a liquid crystal display (LCD) panel includes a color filter substrate, an array substrates and a liquid crystal layer disposed between the two substrates. A LCD device display image using the birefringence effect of a liquid crystal; therefore, the stability of liquid crystal layer thickness has an important impact on the quality of display of the LCD device. In the prior art, the color filter substrate and the array substrate are parallel and opposite to each other, the thickness of a liquid crystal layer (liquid crystal cell gap) is controlled based by an opaque spacer disposed between the two substrates.

Under ordinary circumstances, the number of spacers per square millimeter in a display panel reaches over a hundred. Meanwhile, to ensure the consistency in the capability for maintaining a constant cell gap throughout the display panel, the spacers are uniformly distributed within the region of a black matrix.

In an embodiment, a via hole is located within an area of the insulation layer on which the orthographic projection of a spacer is projected, and it means that the position design of the via hole needs to consider the distribution of spacers. As mentioned above, due to the large number of the spacers and their relatively uniform distribution; the actual limitation on the position design of the via hole is moderate, and easy to realize it.

Capacitive touch screen can be categorized into self capacitance touch screen and mutual capacitance touch screen.

As for the self capacitance touch screen, it requires to use transparent conductive materials (such as ITO) to fabricate touch electrodes, and these touch electrodes with respect to ground form capacitance respectively and the capacitance is the so-called self capacitance, that is, the capacitance of an electrode with respect to ground. When a pointing object such as a finger or a stylus implements a touch operation, the pointing object will change the capacitance of the electrode, and a location can be determined according to the change in capacitance.

The mutual capacitance touch screen also makes use of transparent conductive materials (such as ITO) to produce touch electrodes arranged in different layers, where the difference between the mutual capacitance control screen and the self capacitance touch screen lies in that the intersection of electrodes arranged on different layers form a capacitance, that is, a pair of touch electrodes respectively form the two electrodes of a capacitor. Once the pointing object implements a touch operation, it will affect the coupling between two electrodes near the touch point, and change the capacitance between the two electrodes, where a location can be determined according to the change in capacitance.

However, regardless of being a self capacitance touch type or a mutual capacitance touch type, the electrodes (as for mutual capacitance touch type, touch electrodes include a transmission electrode and an induction electrode arranged at different layers, and for the self capacitance touch type, touch electrodes only include mutual capacitance touch electrodes arranged on the same layer) are required to be connected with lines so as to transmit signals. When the lines and the touch electrodes are disposed in different layers, the aforesaid problems would arise. Therefore, the scheme of designing the via hole of an embodiment can be used in the self capacitance touch electrode of the self capacitance touch type, and also used in an transmission electrode and/or an induction electrode of the mutual capacitance touch type.

That is, the aforesaid touch electrode can be a self capacitance touch electrode or a mutual capacitance touch electrode.

In a specific embodiment of this aspect, when a via hole is located within an area of the insulation layer on which the orthographic projection of a spacer is projected, the amount of light irradiating on the area where the via hole is located could be reduced, or the amount of light affected by the via hole and seen by the user could be reduced, both are able to reduce the impact on the display brought by the via hole.

In ordinary designs, a spacer usually includes a main spacer and an auxiliary spacer. Although the main spacer and the auxiliary spacer vary in their function on supporting the panel, but both have a common characteristic, that is, locating in the display area and being opaque.

Accordingly, in an embodiment, a via hole, connecting the touch electrodes and the lines arranged at different layers, could be located within an area of the insulation layer on which the orthographic projection of a main spacer is projected, or could be located within an area of the insulation layer on which the orthographic projection of an auxiliary spacer is projected, both can reduce the impact on the display brought by the via hole.

As explained above, the reason why the via hole is located within an area of the insulation layer on which the orthographic projection of a spacer is projected can reduce the impact on the display by the via hole, is that the amount of light irradiating on the area where the via hole is located could be reduced, or the amount of light affected by the via hole and seen by the user could be diminished. In conclusion, they all make use of the blocking effect of spacers to the light.

Accordingly, although the via hole is either located within an area of the insulation layer on which the orthographic projection of a main spacer is projected, or located within an area of the insulation layer on which the orthographic projection of an auxiliary spacer is projected. However, viewing from the angle of blocking the light, the main spacer, relatively larger in volume, can play a more significant role. Therefore, in an embodiment, the via holes are disposed within an area of the insulation layer on which the orthographic projection of a main spacer is projected, for better blocking the via hole, boosting the display effect; that is, as the spacer includes a main spacer and a auxiliary spacer, the via holes is disposed within an area of the insulation layer on which the orthographic projection of a main spacer is projected.

In the fabrication process of substrates, when a via hole exists, a segment difference will appear on a subsequent produced film layer. From a visual point of view, a recession will appear on the surface of a finally formed array substrate or a color filter substrate. While such a recession exists, the main spacer could be not contact with any surface, leading to the outcome that the main spacer fails to achieve a supporting function. Therefore, in an embodiment, the number of via holes should be controlled to ensure the rest of the main spacers can play a supporting role to the substrates.

Accordingly, in an embodiment of the present invention, the number of the via holes is less than a first threshold, such that the number of the main spacers, where there is no via holes within the areas of the insulation layer on which the orthographic projection of the main spacers are projected, exceeds a second threshold.

Through the foregoing setting, a sufficient number of reserved main spacers can play the original supporting role. In an embodiment, the number of the via holes and the number of the main spacers, where there is no via holes within the areas of the insulation layer on which the orthographic projection of the main spacers are projected, are interrelated, so that the impact on the display brought by the via holes is reduced, and the control over the cell gap of the display panel is ensured.

As mentioned above, under ordinary circumstances, the number of disposed spacers per square millimeter in a display panel reaches over a hundred. Meanwhile, to ensure the consistency in the capability for maintaining a constant cell gap throughout the display panel, the spacers are uniformly distributed within the region of a black matrix. Accordingly, in an embodiment, the number of the via holes may be determined based on the number of spacers in the region thereof, as long as it assures a control over the cell gap throughout the display panel.

In the aforementioned display panel, at least one main spacer, where there is no via holes within the area of the insulation layer on which the orthographic projection of the at least one main spacer is projected, is arranged between main spacers corresponding to adjacent via holes which correspond to the same line, to assure the control over the cell gap of the display panel in a specific area.

Examples of this are described as follows.

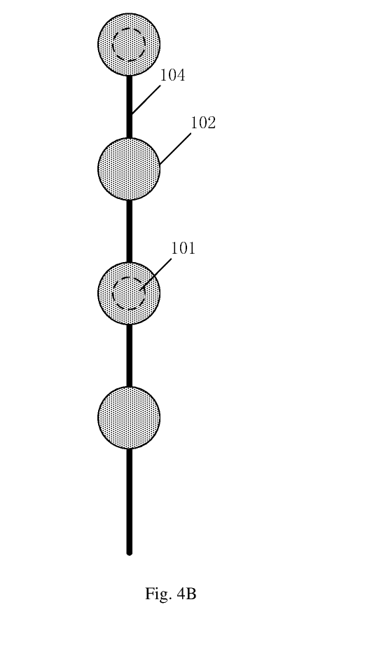

With reference to FIGS. 4A and 4B, assuming for a certain touch electrode and the corresponding lines 104 , there are plural regions that correspond to plural spacers 102, via holes101 can be arranged on the plural resgions, once the number of via holes are large, there are a variety of position designs for the via holes as follows.

A design scheme is shown in FIG. 4A, that is: the spacers, where there are via holes within the regions of the insulation layer on which the orthographic projection of the spacers are projected, are continuously distributed; and

A design scheme shown in FIG. 4B, that is: the spacers, where there are via holes within the regions of the insulation layer on which the orthographic projection of the spacers are projected, are not continuously distributed. Namely, at least one main spacer, where there is no via holes within the area of the insulation layer on which the orthographic projection of the at least one main spacer is projected, is arranged between main spacers corresponding to adjacent via holes which correspond to the same line.

However, as mentioned above, when there are via holes, a segment difference will appear on the subsequent produced film layers. From a visual point of view, a recession will appear on the surface of a finally formed array substrate or a color filter substrate. While such a recession exists, the main spacer could be not contact any surface, leading to the outcome that the main spacer fails to achieve supporting function.

Accordingly, according to the scheme of FIG. 4A, when the amount of via holes corresponding to a certain line are large, recessions will appear on the surface of the array substrate/color filter substrate if the via holes are not distributed in a decentralized way, and the recessions with respect to main spacers are continuously distributed, leading to the plural successively arranged main spacers being not contact any surface, and boosting the likelihood of panel collapse on a certain area.

According to the scheme of FIG. 4B, at least one main spacer, where there is no via holes within the area of the insulation layer on which the orthographic projection of the at least one main spacer is projected, is arranged between main spacers corresponding to adjacent via holes which correspond to the same such that the recessions appearing on the surface of the array substrate/color filter substrate are distributed in a decentralized way, which reduces the likelihood of panel collapse on a certain area.

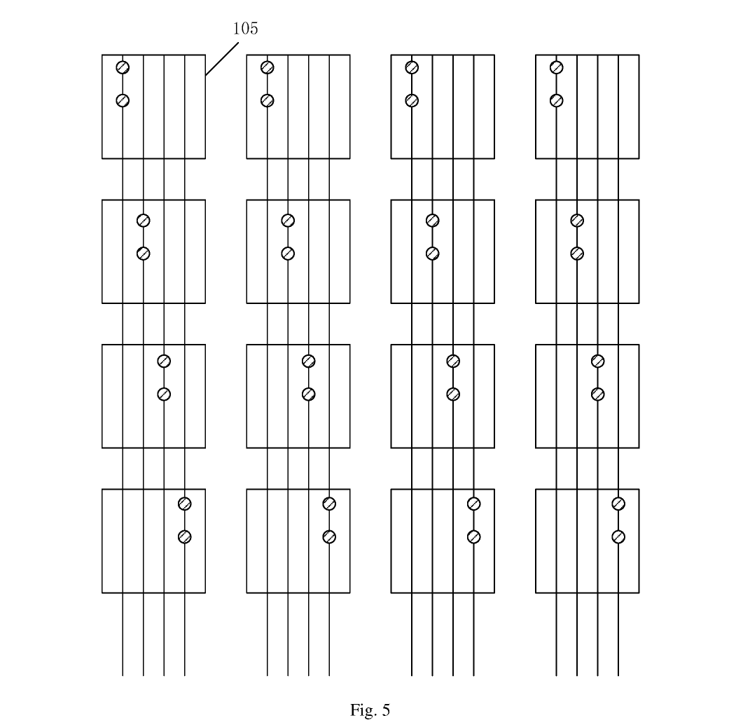

It should be understood that all of the lines, touch electrodes and via holes will bring certain adverse impact on the display, and a very important indicator for the quality of the display is the uniformity of display. Therefore, in an embodiment, in order to boost the uniformity of display, as shown in FIG. 5, the plural touch electrodes 105 are identical in size and shape, arranged in a matrix. The portions of the plural lines located in the display are disposed parallel to each other, having the same length and width, and the number of lines in an area covered by each column of touch electrodes or each row of touch electrodes is the same.

Through the foregoing settings, the capacitance formed between each touch electrode and a line is identical, achieving a wiring scheme with equal capacitance, which enables the impact of each touch electrode on the display is identical, thereby improving the uniformity of display.

Meanwhile, in order to further boost the uniformity of display, in an embodiment of this aspect, within a column of touch electrodes or a row of touch electrodes, the number of via holes corresponding to each touch electrode and the position of the via hole with respect to the touch electrode are identical.

As shown in FIG.5, the number of via holes corresponding to each touch electrode and the position of the via hole relative to the touch electrode are identical in a column of touch electrodes. However, when the aforesaid lines are disposed in a lateral direction, the number of via holes corresponding to each touch electrode and the position of the via hole with respect to the touch electrode are identical in a row of touch electrodes, which will not be described in detail herein.

As mentioned earlier, in an embodiment, the aforementioned touch electrode could be disposed in an array substrate of the transmissive display panel, in a color filter substrate of the transmissive display panel, in an array substrate of the reflective display panel, in a color filter substrate of the reflective display panel, in an array substrate of the transflective display panel, or in a color filter substrate of the transflective the display panel.

In the display panel, there is another electrode, namely, a common electrode. In an embodiment, in order to save process and production procedures, the touch electrode is also used as the common electrode, that is, the touch electrode is used both for the touch function and for providing a common voltage.

In this way, a time-dividing driving approach is adopted; the line is used for transmitting touch detection signals during a touch stage, and for transmitting common electrode signals to the touch electrode during a display stage.

When the time-dividing driving approach is adopted, the duration of each frame (V-sync) is divided into a display period (Display) and a touch period (Touch), for instance, the time period for displaying a frame in a driving sequence is 16.7 ms, where 5 ms can be selected as the touch period, and the rest 11.7 ms as the display period. Of course, it is available to adaptively adjust the timing of the two based on the processing power of the IC chip, which will not be specifically defined herein.

In the display period (Display), each of the gate signal lines Gate 1, Gate 2 . . . Gate n is sequentially applied by a gate scan signal, and the data signal line Data is applied by a gray-scale signal, the touch electrode works as a common electrode correspondingly, and the IC chip connected thereto provides a constant common electrode signal to the touch electrode, for realizing the display function. In the touch period (Touch), the IC chip connected thereto interacts with each touch electrode (different interactions are subject to different touch approaches, belonging to the prior art, and will not be described in detail herein), to realize the touch function. In the touch period, there is no signal inputted to each of the gate signal lines and the data signal lines of the touch screen.

By way of the foregoing approach, the touch electrode is also sued as a common electrode, which saves production processes.

The disclosed embodiments also provide a display device comprising the aforementioned display panel.

The display device of an embodiment could be a liquid crystal panel, a mobile phone, a tablet computer, a television set, a monitor, a notebook computer, a digital picture frame, a navigation system and the like that is either a products or a component having the display function. The implementation of the display device can be found in the foregoing embodiments of the display processing apparatus, where the contents will not be reiterated herein.

The above are merely the preferred embodiments of the present disclosure. Obviously, a person skilled in the art may make further modifications and improvements without departing from the principle of the present disclosure, and these modifications and improvements shall also fall within the scope of the present disclosure.

What is claimed is:

1. A display panel, comprising an array substrate, a color filter substrate and at least one spacer disposed between the array substrate and the color filter substrate, where the array substrate or the color filter substrate is provided with a plurality of touch electrodes disposed in a same layer and separated from each other, a plurality of lines arranged in different layers from the touch electrodes, and an insulation layer disposed between the touch electrodes and the lines, wherein the insulation layer is provided with via holes for connecting the corresponding touch electrodes and the lines, and the via hole being located within a region of the insulation layer on which an orthographic projection of the spacer is projected.

2. The display panel according to claim 1, wherein the touch electrode is a self-capacitance touch electrode or a mutual-capacitance touch electrode.

3. The display panel according to claim 1, wherein the spacer comprises a main spacer and an auxiliary spacer, and the via holes are located within a region of the insulation layer on which an orthographic projection of the main spacer is projected.

4. The display panel according to claim 3, wherein the number of the via holes is less than a first threshold, such that the number of the main spacers, where there is no via holes within the areas of the insulation layer on which the orthographic projection of the main spacers are projected, exceeds a second threshold.

5. The display panel according to claim 4, wherein at least one main spacer, where there is no via holes within the area of the insulation layer on which the orthographic projection of the at least one main spacer is projected, is arranged between main spacers corresponding to adjacent via holes which correspond to a same line.

6. The display panel according to claim 1, wherein the plurality of touch electrodes have the same size and shape and are arranged in a matrix manner, where portions of the plurality of lines located in the display area are disposed in parallel, and have the same length and width, and the number of the lines located in a region covered by each column of touch electrodes or each row of touch electrodes is identical.

7. The display panel according to claim 1, wherein the lines are used for transmitting touch detection signals during a touch stage and for transmitting common electrode signals to the touch electrodes during a display stage.

8. The display panel according to claims 1, wherein the plurality of touch electrodes have the same size and shape and are arranged in a matrix manner, within a column of touch electrodes or a row of touch electrodes, the number of the via holes corresponding to each touch electrode is identical and the positions corresponding to the touch electrodes are same.

9. A display device, comprising the display panel according to claim 1.

10. The display device according to claim 9, wherein the touch electrode is a self-capacitance touch electrode or a mutual-capacitance touch electrode.

11. The display device according to claim 9, wherein the spacer comprises a main spacer and an auxiliary spacer, and the via holes are located within a region of the insulation layer on which an orthographic projection of the main spacer is projected.

12. The display device according to claim 11, wherein the number of the via holes is less than a first threshold, such that the number of the main spacers, where there is no via holes within the areas of the insulation layer on which the orthographic projection of the main spacers are projected, exceeds a second threshold.

13. The display device according to claim 12, wherein at least one main spacer, where there is no via holes within the area of the insulation layer on which the orthographic projection of the at least one main spacer is projected, is arranged between main spacers corresponding to adjacent via holes which correspond to a same line.

14. The display device according to claim 9, wherein the plurality of touch electrodes have the same size and shape and are arranged in a matrix manner, where portions of the plurality of lines located in the display area are disposed in parallel, and have the same length and width, and the number of the lines located in a region covered by each column of touch electrodes or each row of touch electrodes is identical.

15. The display device according to claim 9, wherein the lines are used for transmitting touch detection signals during a touch stage and for transmitting common electrode signals to the touch electrodes during a display stage.

16. The display device according to claims 9, wherein the plurality of touch electrodes have the same size and shape and are arranged in a matrix manner, within a column of touch electrodes or a row of touch electrodes, the number of the via holes corresponding to each touch electrode is identical and the positions corresponding to the touch electrodes are same.

17. The display panel according to claim 2, wherein the plurality of touch electrodes have the same size and shape and are arranged in a matrix manner, where portions of the plurality of lines located in the display area are disposed in parallel, and have the same length and width, and the number of the lines located in a region covered by each column of touch electrodes or each row of touch electrodes is identical.

18. The display panel according to claim 2, wherein the lines are used for transmitting touch detection signals during a touch stage and for transmitting common electrode signals to the touch electrodes during a display stage.

19. The display panel according to claim 3, wherein the plurality of touch electrodes have the same size and shape and are arranged in a matrix manner, where portions of the plurality of lines located in the display area are disposed in parallel, and have the same length and width, and the number of the lines located in a region covered by each column of touch electrodes or each row of touch electrodes is identical.

20. The display panel according to claim 3, wherein the lines are used for transmitting touch detection signals during a touch stage and for transmitting common electrode signals to the touch electrodes during a display stage.
